(19) United States
(12) Patent Application Publication
(10) Pub. No.: US 2003/0236333 A1
(43) Pub. Date: Dec. 25, 2003

(54) Rubber mixtures containing copolymers for the production of tires

(76) Inventors: Adrian Rawlinson, Leverkusen (DE); Peter Wendling, Leverkusen (DE); Rudiger Engehausen, Dormagen (DE)

Correspondence Address: BAYER POLYMERS LLC, 100 BAYER ROAD, PITTSBURGH, PA, 15205, US

(21) Appl. No.: 10/435,844

(22) Filed: May 12, 2003

(30) Foreign Application Priority Data
Jun. 21, 2002 (DE) 10227733.8

(51) Int. Cl. C08K 5/09

(52) U.S. Cl. 524/306

(57) ABSTRACT

The present invention relates to the use of rubber mixtures containing copolymers based on an unsaturated olefinic nitrile, a conjugated diene and optionally a polymerizable carboxylic acid, at least one non-polar rubber and at least one polar synthetic plasticizer for the production of tires.

### FIELD OF THE INVENTION

The present invention relates to the use of rubber mixtures containing copolymers, based on an unsaturated olefinic nitrile, a conjugated diene and optionally a polymerizable carboxylic acid, at least one non-polar rubber and at least one polar synthetic plasticizer for the production of tires.

### BACKGROUND OF THE INVENTION

It is known to improve wet skid resistance and abrasion resistance by using copolymers based on a conjugated diene and an olefinically unsaturated nitrile. See for example, JP-A 63270751, U.S. Pat. No. 4,894,420, WO 92/20737, WO 96/35749 and WO 96/35750.

However, the copolymers described in the above-mentioned patent publications or their mixtures with other rubbers are still in need of improvement in terms of dynamic properties such as dynamic modulus at low temperatures and the combination of the tire properties rolling resistance, wet skid resistance and abrasion.

It is known that carbon black or silica tread mixtures based on non-polar rubbers or mixtures thereof containing butadiene-acrylonitrile rubber (NBR) lead to a clear increase in the tan δ value at 0° C., which indicates improved wet skid resistance. In addition, depending on the mixture, an improved abrasion resistance is found. However, the use of NBR in the above mixtures displays negative effects such as a clearly increased dynamic modulus at 0° C. and an increased tan δ value at 60° C. A tread mixture with a high dynamic modulus at 0° C. has disadvantages at a low operating temperature in the properties of ABS braking performance in the wet, and in the driving performance. A high tan δ value at 60° C. also indicates a higher rolling resistance.

An object of the present invention was to provide rubber mixtures based on copolymers of the above-mentioned composition, which exhibit improved dynamic properties such as dynamic modulus at low temperatures together with an improved combination of the tire properties rolling resistance, wet skid resistance and abrasion resistance.

The object is achieved in that polar synthetic plasticizers are added to the rubber mixtures.

### SUMMARY OF THE INVENTION

The present invention therefore provides rubber mixtures for the production of tires, containing (a) at least one copolymer based on an olefinically unsaturated nitrile, a conjugated diene and optionally a polymerizable carboxylic acid, (b) at least one non-polar rubber, and (c) at least one polar synthetic plasticizer, wherein the component (a) is present in quantities of 1 to 99 parts by weight, component (b) in quantities of 99 to 1 parts by weight and component (c) in quantities of 0.5 to 50 parts by weight, based on 100 parts by weight of the total quantity of rubber.

### DETAILED DESCRIPTION OF THE INVENTION

Rubber mixtures in which component (a) is present in quantities of 1 to 50 parts by weight, preferably 5 to 30 parts by weight, component (b) in quantities of 50 to 99 parts by weight, preferably, 70 to 95 parts by weight, and component (c) in quantities of 1 to 40 parts by weight, preferably, 5 to 30 parts by weight, based on 100 parts by weight of the total quantity of rubber, are preferred.

The copolymer used as component (a) in the rubber mixtures according to the present invention is based on unsaturated olefinic nitrites, conjugated dienes and optionally polymerizable carboxylic acids.

The following are suitable as conjugated dienes: 1,3-butadiene, 2,3-dimethyl-1,3-butadiene, 2-methyl-1,3-butadiene, 2-ethyl-1,3-butadiene, 1,3-pentadiene, 2-methyl-1,3-pentadiene, 1,3-hexadiene, 2-phenyl-1,3-butadiene, 3,4-dimethyl-1,3-hexadiene, 1,3-heptadiene, 1,3-octadiene, 4,5-diethyl-1,3-octadiene, 3-methyl-1,3-pentadiene, 4-methyl-1,3-pentadiene or mixtures of the above dienes. 1,3-Butadiene and 2-methyl-1,3-butadiene are preferred. 1,3-Butadiene is preferred.

Acrylonitrile, methacrylonitrile, ethyl acrylonitrile, crotononitrile, 2-pentenenitrile or mixtures thereof can be used as olefinically unsaturated nitrites for synthesizing the copolymers. Acrylonitrile is preferred.

Acrylic acid, methacrylic acid, fumaric acid and maleic acid, for example, are suitable as polymerizable carboxylic acids.

All the constituents can also be used in a mixture with one another.

The copolymers to be used according to the present invention contain the conjugated dienes in quantities of about 50 to 90 wt. % and the olefinically unsaturated nitrites in quantities of about 10 to 50 wt. %, the quantity of the individual components adding up to 100 wt. %.

The conjugated dienes are preferably used in quantities of 50 to 85 wt. % and the olefinically unsaturated nitrites in quantities of 15 to 50 wt. %.

If the component (a) additionally contains polymerizable carboxylic acids, these are present in quantities of 0.1 to 10 wt. %, based on the quantity of all the components. The ratio of the conjugated dienes to the olefinically unsaturated nitrites in component (a) is not affected by the addition of polymerizable carboxylic acids.

Depending on the quantities of the constituents used, the glass transition temperature of the copolymers used according to the invention is about −60 to 0° C., preferably −45 to −15° C.

The copolymers used according to the present invention, e.g. butadiene-acrylonitrile copolymers (NBR) or carboxylated NBR, are known from the patent publications mentioned above, for example, as is the production thereof.

All types of natural rubbers, such as natural rubber (NR), and corresponding synthetic rubbers, such as e.g. polybutadiene (BR), styrene-butadiene copolymers (SBR), polyisoprene rubbers (IR), isoprene-butadiene rubbers, isoprene-butadiene-styrene rubbers and ethylene-propylene rubbers, can be used as non-polar rubbers for the rubber mixtures according to the present invention. Polybutadiene, styrene-butadiene copolymers and natural rubbers are preferably used. The additional non-polar rubbers mentioned, used in the rubber mixtures according to the present invention, can of course also contain added aromatic-, naphthenic- or paraffinic-based oils, as is conventional.

The above-mentioned non-polar rubbers are known and are produced by conventional free-radical emulsion polymerization, free-radical solution polymerization, anionic or cationic polymerization or by Ziegler-Natta polymerization.

As mentioned, it is important for the physical properties of the rubber mixtures according to the present invention, or the vulcanizates or moldings produced therefrom, that polar synthetic plasticizers are added to the rubber mixtures. Those containing e.g. ester or ether groups in the molecule are suitable as polar synthetic plasticizers, for example phthalates, such as dibutyl phthalates (DBP), dioctyl phthalates (DOP), diisononyl phthalates (DINP), diisodecyl phthalates (DIDP), diisotridecyl phthalates (DTDP), diundecyl phthalates (DUP), sebacates, such as dioctyl sebacates (DOS), dibutyl sebacates (DBS), adipates, such as dioctyl adipates (DOA), diisodecyl adipates (DIDA), diisononyl adipates (DINA), di(butoxy-ethoxy-ethyl) adipates, phosphates, such as tricresyl phosphates (TCP), trixylyl phosphates (TXP), trioctyl phosphates (TOF), diphenylcresyl phosphates, diphenyloctyl phosphates, trichloroethyl phosphates, stearates, such as butyl stearate, azelates, such as dioctyl azelates, oleates, such as dibutyl oleate, trimellitates, such as trioctyl mellitate, trilinear C₇-C₉ trimellitates, glycolates, such as dibutylmethylene bisthioglycolates, di-2-ethylhexyl ester thiodiglycolates, nylonates, such as dioctyl nylonate, diisodecyl nylonate, phenyl alkyl sulfonates, butyl carbitol formal, and mixed esters of adipic, glutaric and succinic acid.

In addition, the following are also suitable as polar plasticizers: chlorinated paraffins with a chlorine content of 40 to 70 wt. % and epoxy ester-based, polyester- and polyether-based, ether-thioether-based and phenolsulfonate-based plasticizers.

The polar synthetic plasticizers can be used both individually and in a mixture with one another. The preferred mixing ratio depends on the intended application of the rubber mixtures according to the present invention.

Plasticizers based on phthalic acid, sebacic acid and adipic acid are preferred.

Components (a) and (c) can also be used as a masterbatch. This masterbatch can be produced either in a kneader by mixing components (a) and (c) or by mixing component (a) in the form of its latex with component (c) followed by coagulation and drying.

In addition to the polar synthetic plasticizers, the rubber mixtures according to the present invention can, of course, also contain the known fillers and rubber auxiliaries, such as pigments, zinc oxide, stearic acid, vulcanization accelerators, vulcanizing agents, e.g. based on sulfur and peroxide, stabilizers, antioxidants, resins, oils, waxes and inhibitors.

Both the known carbon blacks and silicas, and silicates, titanium dioxide, chalk or clay or mixtures thereof are suitable as fillers for the rubber mixtures according to the present invention. Carbon black and silica are preferably used as fillers.

When silicas are used in the rubber mixtures, so-called filler activators, such as bis-3-(triethoxysilylpropyl)tetrasulfane, can also be added in a known manner.

The above-mentioned additives and auxiliaries are also known to the person skilled in the art and are described in Kautschuk-Technology by Werner Hoffmann, Habilitationsschrift der Fakultädt für Maschinenwesen, T H Aachen, 1975; Handbuch für die Gummiindustrie bei Bayer AG Leverkusen, Hoffmann, W.; Kautschuktechnology Stuttgart (Genter 1980) and in Helle Füllstoffe in Polymeren, Gummi Faser Kunststoffe 42 (1989) part 11.

The fillers and the rubber auxiliaries mentioned above are used in the conventional quantities. The preferred quantities in each case depend, among other things, on the intended application of the rubber mixtures and can easily be determined by appropriate preliminary tests.

The rubber mixtures according to the present invention can be produced by intensively mixing together the individual components in suitable mixers, such as a roller or a kneader.

The rubber mixtures according to the present invention can be vulcanized by conventional means, the most useful vulcanization process being dependent on the application of the rubber mixtures.

The rubber mixtures according to the present invention can be used for the production of all types of tire components.

The use of the rubber mixtures according to the present invention for the production of tire treads is preferred.

In the following examples, the properties of the rubber mixtures according to the present invention, the comparative rubber mixtures and the resulting vulcanizates were measured as follows:

(1) The Mooney viscosity of the rubbers was determined in accordance with DIN 53523.

(2) The tensile strength of the vulcanizates was determined in accordance with DIN 53504.

(3) The elongation at break of the vulcanizates was determined in accordance with DIN 53504.

(4) The modulus of the vulcanizates at 100% and 300% elongation was determined in accordance with DIN 53504.

(5) The hardness of the vulcanizates at 70° C. was determined in accordance with DIN 53505.

(6) The abrasion of the vulcanizates was determined in accordance with DIN 53516.

(7) The dynamic modulus and the tan δ values of the vulcanizates were determined in accordance with DIN 53513

### EXAMPLES

The following components were used for the comparative rubber mixture 1 and the rubber mixtures 2 and 3 according to the present invention:

Krylene® 1500 (emulsion SBR, approx. 23.5% styrene, Mooney viscosity 50, produced by Bayer)

Krynac® 34.50 (emulsion NBR, approx. 67% butadiene and approx. 33% acrylonitrile, Mooney viscosity 45, produced by Bayer)

Krynac® 50.75 (emulsion NBR, approx. 51.5% butadiene and approx. 48.5% acrylonitrile, Mooney viscosity 80, produced by Bayer)

Perbunan® NT 3945 (emulsion NBR approx. 61% butadiene and approx 39% acrylonitrile, Mooney viscosity 46, produced by Bayer AG)

Krynac® X 7.40 (carboxylated emulsion NBR approx. 66% butadiene, approx. 27% acrylonitrile and approx. 7% methacrylic acid, Mooney viscosity 38, produced by Bayer)

NR (natural rubber TSR 5, cis-1,3-polyisoprene) Vulkasil S (activated silica, a product of Bayer AG),

Si 69® (bis-3-(triethoxysilylpropyl)tetrasulfane, produced by Degussa AG)

Renopal 450 (aromatic mineral oil plasticizer, produced by Fuchs Chemie)

Corax® N 339 (carbon black, produced by Degussa Hüls AG)

Stearic acid

ZnO (zinc oxide)

Sulfur

Vulkanox® 4010 NA (N-isopropyl-N′-phenyl-p-phenylenediamine, produced by Bayer AG)

Vulkanox® 4020 (N-(1,3-dimethylbutyl)-N′-phenyl-p-phenylenediamine, produced by Bayer AG)

Vulkacit® D (diphenylguanidine, produced by Bayer AG)

Vulkacit® CZ/C (N-cyclohexyl-2-benzothiazyl sulfenamide, produced by Bayer AG)

DOP: Vestinol A H, (dioctyl phthalate, Hüls AG)

The individual parts by weight of the components are listed in Tables 1 and 2.

The components were mixed in a kneader (Werner & Pfleiderer GK 1.5) at 50 rpm. The kneader temperature was 60° C. The vulcanization accelerators were mixed in using a roller.

The results of the tests are listed in Tables 1 and 2.

TABLE 1

| | Comp. | | Comp. | | Comp. | |
|---|---|---|---|---|---|---|
| | Ex. 1 | Ex. 1 | Ex. 2 | Ex. 2 | Ex. 3 | Ex. 3 |
| Krylene 1500 | 80 | 80 | 80 | 80 | 80 | 80 |
| Krynac 34.50 | 20 | 20 | 0 | 0 | 0 | 0 |
| Krynac 50.75 | 0 | 0 | 20 | 20 | 0 | 0 |
| Krynac X 7.40 | 0 | 0 | 0 | 0 | 20 | 20 |
| Corax N-339 | 50 | 50 | 50 | 50 | 50 | 50 |
| Renopal 450 | 30 | 15 | 30 | 15 | 30 | 15 |
| DOP | 0 | 15 | 0 | 15 | 0 | 15 |
| Stearic acid | 2 | 2 | 2 | 2 | 2 | 2 |
| Zinc oxide | 3 | 3 | 3 | 3 | 3 | 3 |
| Vulkanox | 1 | 1 | 1 | 1 | 1 | 1 |
| 4010 NA | | | | | | |
| Vulkanox 4020 | 1 | 1 | 1 | 1 | 1 | 1 |
| Sulfur | 2 | 2 | 2 | 2 | 2 | 2 |
| Vulkacit CZ | 1.5 | 1.5 | 1.5 | 1.5 | 1.5 | 1.5 |
| Vulkacit D | 0.2 | 0.2 | 0.2 | 0.2 | 0.2 | 0.2 |
| Tensile strength | 21.8 | 21.2 | 22.1 | 21.3 | 19.7 | 16.9 |
| (MPA) | 670 | 655 | 665 | 630 | 645 | 575 |
| Elogation at break | 1.5 | 1.5 | 1.5 | 1.6 | 2.3 | 2.1 |
| (%) | 6.0 | 6.2 | 6.4 | 6.9 | 7.1 | 7.1 |
| M 100% (MPa) | 56 | 55 | 57 | 56 | 63 | 61 |
| M 300% (MPa) | 150 | 120 | 165 | 160 | 115 | 100 |
| Hardness (23° C.) | | | | | | |
| DIN abrasion, | | | | | | |
| P-60 (mm3) | | | | | | |
| tan d 0° C. | 0.533 | 0.410 | 0.212 | 0.344 | 0.212 | 0.413 |
| tan d 60° C. | 0.212 | 0.191 | 0.211 | 0.191 | 0.257 | 0.245 |
| E * 0° C. (MPa) | 27.1 | 15.3 | 75.1 | 43.6 | 118.5 | 51.9 |

As shown by the results in Table 1, the addition of polar plasticizers such as DOP to carbon black filled blends of ESBR and NBR leads to a significant reduction in the complex dynamic modulus (E*), thus improving the properties when used in tire treads.

In example 1 according to the present invention, 15 phr of the aromatic oil are replaced by 15 phr of DOP in a mixture containing nitrile rubber. As a result, by comparison with the prior art (comparative example 1), not only is the complex dynamic modulus (E*) at 0° C. significantly reduced, but also the value for tan delta 60° C. (predictor of lower rolling resistance), and an improvement in the abrasion resistance is seen.

In examples 2 and 3, similar results can be seen: when DOP is used in mixtures with NBR (50% acrylonitrile) or carboxylated NBR, the complex dynamic modulus (E*) at 0° C. and tan delta 60° C. are again reduced and an improvement in the abrasion resistance is again seen. In addition, a higher value for tan delta 0° C. is obtained (predictor of improved wet skid properties).

TABLE 2

| | Comp. | | Comp. | | Comp. | |
|---|---|---|---|---|---|---|
| | Ex. 4 | Ex. 4 | Ex. 5 | Ex. 5 | Ex. 6 | Ex. 6 |
| Krylene 1500 | 80 | 80 | 80 | 80 | 80 | 80 |
| Perbunan NT 3945 | 20 | 20 | 0 | 0 | 0 | 0 |
| Krynac 50.75 | 0 | 0 | 20 | 20 | 0 | 0 |
| Krynac X 7.40 | 0 | 0 | 0 | 0 | 20 | 20 |
| Vulkasil S | 50 | 50 | 50 | 50 | 50 | 50 |
| Si 69 | 6 | 6 | 6 | 6 | 6 | 6 |
| Renopal 450 | 30 | 15 | 30 | 15 | 30 | 15 |
| DOP | 0 | 15 | 0 | 15 | 0 | 15 |
| Stearic acid | 2 | 2 | 2 | 2 | 2 | 2 |
| Zinc oxide | 3 | 3 | 3 | 3 | 3 | 3 |
| Vulkanox 4010 NA | 1 | 1 | 1 | 1 | 1 | 1 |
| Vulkanox 4020 | 1 | 1 | 1 | 1 | 1 | 1 |
| Sulfur | 2 | 2 | 2 | 2 | 2 | 2 |
| Vulkacit CZ | 1.5 | 1.5 | 1.5 | 1.5 | 1.5 | 1.5 |
| Vulkacit D | 0.2 | 0.2 | 0.2 | 0.2 | 0.2 | 0.2 |
| Tensile strength | 23.2 | 18.2 | 20.5 | 19.7 | 16.1 | 16.6 |
| (MPa) | 645 | 565 | 600 | 590 | 550 | 560 |
| Elongation at break | 2.1 | 2.0 | 2.2 | 2.1 | 2.7 | 2.6 |
| (%) | 7.2 | 6.8 | 7.3 | 7.0 | 7.4 | 7.3 |
| M 100% (MPa) | 59 | 60 | 60 | 61 | 65 | 64 |
| M 300% (MPa) | 130 | 125 | 125 | 125 | 100 | 100 |
| Hardness (23° C.) | | | | | | |
| DIN abrasion, | | | | | | |
| P-60 (mm3) | | | | | | |
| tan d 0° C. | 0.441 | 0.372 | 0.375 | 0.369 | 0.290 | 0.360 |
| tan d 60° C. | 0.123 | 0.119 | 0.123 | 0.118 | 0.180 | 0.160 |
| E * 0° C. (MPa) | 21.6 | 13.4 | 29.3 | 25.4 | 66.2 | 42.1 |

The advantages of using polar plasticizers such as DOP in carbon black filled SBR and NBR mixtures can also be seen in silica mixtures (see Table 2).

In examples 1 to 3, 15 phr of the aromatic oil are replaced with 15 phr of DOP. The mixtures contain NBR (39% ACN, example 1), NBR (50% ACN, example 2) and carboxylated NBR (example 3).

In the silica mixtures, the complex dynamic modulus (E*) at 0° C. is significantly reduced compared with the prior art. Compared with the prior art, the abrasion resistance is the same or better. The same applies to tan delta 60° C., the tan delta 60° C. being reduced (predictor of lower rolling resistance) and the tan delta 0° C. considerably increased (predictor of improved wet skid properties) particularly when carboxylated NBR is used (example 6).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A rubber mixture comprising
a) at least one copolymer based on an olefinically unsaturated nitrile, a conjugated diene and optionally a polymerizable carboxylic acid
b) at least one non-polar rubber, and
c) at least one polar synthetic plasticizer,
wherein the component a) is present in quantities of 1 to 99 parts by weight, component b) in quantities of 99 to 1 parts by weight and component c) in quantities of 0.5 to 50 parts by weight, based on 100 parts by weight of the total quantity of rubber.

2. The rubber mixture according to claim 1, wherein the conjugated diene is selected from the group consisting of 1,3-butadiene, 2,3-dimethyl-1,3-butadiene, 2-methyl-1,3-butadiene, 2-ethyl-1,3-butadiene, 1,3-pentadiene, 2-methyl-1,3-pentadiene, 1,3-hexadiene, 2-phenyl-1,3-butadiene, 3,4-dimethyl-1,3-hexadiene, 1,3-heptadiene, 1,3-octadiene, 4,5-diethyl-1,3-octadiene, 3-methyl-1,3-pentadiene, 4-methyl-1,3-pentadiene and mixtures thereof.

3. The rubber mixture according to claim 1, wherein the carboxylic acid is selected from the group consisting of acrylic acid, methacrylic acid, fumaric acid, maleic acid and mixtures thereof.

4. The rubber mixture according to claim 1, wherein the olefinically unsturated is selected from the group consisting of acrylonitrile, methacrylonitrile, ethyl acrylonitrile, crotononitrile, 2-pentenenitrile and mixtures thereof.

5. The rubber mixture according to claim 1, wherein the copolymer comprises the conjugated diene in quantities of about 50 to about 90 wt. %.

6. The rubber mixture according to claim 1, wherein the copolymer comprises the olefinically saturated nitrile in quantities of about 10 to about 50 wt. %.

7. The rubber mixture according to claim 1, wherein the copolymer is NBR or carboxylated NBR.

8. The rubber mixture according to claim 1, non-polar rubber is selected from the group consisting of polybutadiene, styrene-butadiene copolymers, natural rubber and mixtures thereof.

9. The rubber mixture according to claim 1, wherein the plasticizer is selected from the group consisting of phthalates, sebacates, adipates, phosphates, stearates, azelates, oleates, trimellitates, glycolates, nylonates, and mixed esters of adipic, glutaric and succinic acid.

10. The rubber mixture according to claim 9, wherein the plasticizer is dioctyl phthalate.

11. A rubber vulcanizate comprising a rubber mixture according to claim 1.

12. A process for preparing a rubber mixture according to claim 1, comprising the step of mixing component (a) and (c).

13. A process for preparing a rubber mixture according to claim 1, comprising the steps of mixing component (a) in latex form with component (c), coagulating the resulting mixture and drying the resulting mixture.
